(19) United States
(12) Patent Application Publication
(10) Pub. No.: US 2025/0171082 A1
(43) Pub. Date: May 29, 2025

(54) VEHICLE INFORMATION PROCESSING DEVICE

(71) Applicant: TOYOTA JIDOSHA KABUSHIKI KAISHA, Toyota-shi (JP)

(72) Inventor: Nobuyuki ITOH, Toyota-shi (JP)

(73) Assignee: TOYOTA JIDOSHA KABUSHIKI KAISHA, Toyota-shi (JP)

(21) Appl. No.: 18/908,979

(22) Filed: Oct. 8, 2024

(30) Foreign Application Priority Data
Nov. 28, 2023 (JP) 2023-200842

(51) Int. Cl. B62D 15/02

(52) U.S. Cl. CPC B62D 15/0295

(57) ABSTRACT

Processing circuitry sets multiple reference positions in an extending direction of a travel lane based on a setting signal generated based on an operation by a user. Each of the reference positions is a specific position in a lateral direction in the travel lane at a position in an extending direction of the travel lane. A target travel trajectory is obtained as an imaginary line formed by connecting the reference positions to each other in the extending direction of the travel lane. The processing circuitry generates instruction information of a steered angle of a steered wheel of a vehicle so as to cause the vehicle to travel along the target travel trajectory.

### CROSS-REFERENCE TO RELATED APPLICATIONS

This application is based upon and claims the benefit of priority from prior Japanese Patent Application No. 2023-200842, filed on Nov. 28, 2023, the entire contents of which are incorporated herein by reference.

### BACKGROUND

### 1. Field

The present disclosure relates to a vehicle information processing device.

### 2. Description of Related Art

A vehicle disclosed in Japanese Laid-Open Patent Publication No. 2020-152137 includes an information processing device. The information processing device assists the driving of the user in steering the vehicle. The information processing device stores, in advance, the characteristics of the steering operation of each of multiple users. While the vehicle is in motion, the information processing device generates instruction information regarding the steered angle of the steered wheels, based on the steering operation characteristics and the road shape, to achieve a travel trajectory that matches the individual preferences of each user. The information processing device controls the steering device based on the instruction information.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicle information processing device includes processing circuitry. The processing circuitry is configured to receive a setting signal related to a target travel trajectory of a vehicle. The setting signal is generated based on an operation by a user. The processing circuitry is also configured to acquire white line information of a travel lane on which the vehicle is traveling and acquire information on a shape of a center line of the travel lane and a width of the travel lane for a predetermined range ahead from a current position of the vehicle based on the white line information. The processing circuitry is also configured to, based on the setting signal, set multiple reference positions of the target travel trajectory in an extending direction of the travel lane. Each of the reference positions is a specific position in a lateral direction in the travel lane at a position in the extending direction of the travel lane. The lateral direction is a direction along a width of the vehicle. The processing circuitry is further configured to generate the target travel trajectory based on the reference positions. The target travel trajectory is an imaginary line obtained by connecting the reference positions to each other in the extending direction of the travel lane. The processing circuitry is additionally configured to generate instruction information of a steered angle of a steered wheel of the vehicle so as to cause the vehicle to travel along the target travel trajectory, and output the instruction information to a steering device of the vehicle so as to adjust the steered angle.

The above-described technical concept allows for the generation of a target travel trajectory that reflects the intention of the user.

In certain scenarios, as part of driver assistance or fully autonomous driving of a vehicle, an information processing device may be responsible for controlling the vehicle's steering. In such cases, considering the user's driving feel and preferences, there may be instances where the user wishes to adjust the travel trajectory while the information processing device continues to control the steering action. For example, the user might want to shift the overall travel trajectory more to the left or right than the current position. From the perspective of incorporating the user's intentions into the vehicle's steering control, the above-described configuration offers improvements.

Other features and aspects will be apparent from the following detailed description, the drawings, and the claims.

### BRIEF DESCRIPTION OF THE DRAWINGS

FIG. 1 is a schematic diagram showing the configuration of a vehicle.

FIG. 2 is a diagram schematically showing an example of the configuration of the interior of the passenger compartment of the vehicle shown in FIG. 1.

FIG. 3 is a flowchart showing a procedure of a trajectory generation process executed by an information processing device shown in FIG. 1.

FIG. 4 is a diagram showing an example of an integrated image displayed by a display shown in FIG. 2.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Overall Configuration of Vehicle

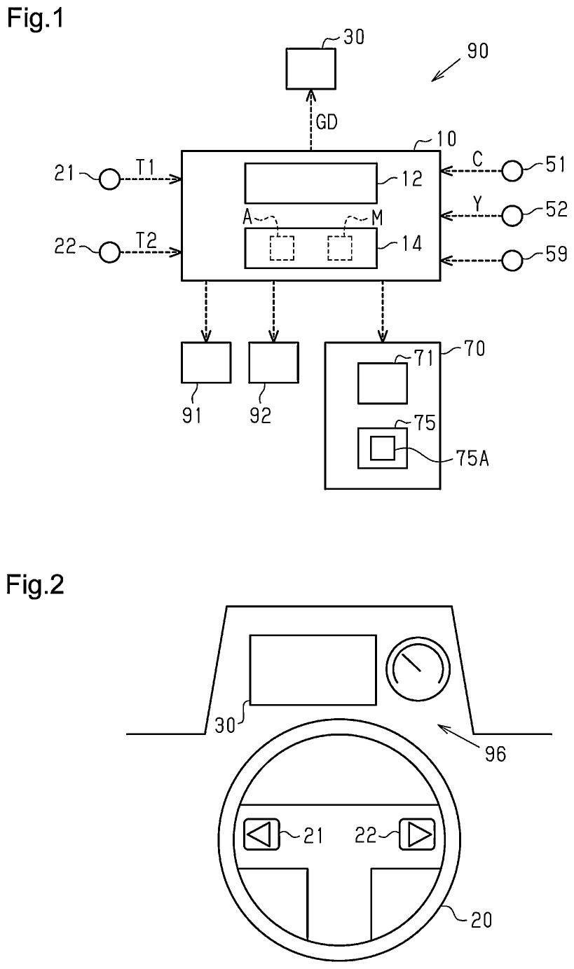

Hereinafter, an embodiment of a vehicle information processing device will be described with reference to the drawings. As shown in FIG. 1, a vehicle 90 includes a drive unit 91, a brake unit 92, a steering unit 70, a display 30, and an information processing device 10.

Although not shown, the drive unit 91 includes a drive source of the vehicle 90 and a drive ECU. An example of a drive source of the vehicle 90 is an engine. The drive source of the vehicle 90 may be a generator motor. The drive ECU is a control device that controls a drive source of the vehicle 90. The drive ECU controls the drive source of the vehicle 90 in accordance with instruction information from the information processing device 10.

Although not shown, the brake unit 92 includes a brake device for each wheel and a brake ECU. The brake device is of a hydraulic type. The brake ECU is a control device that controls each brake device. The brake ECU controls each brake device in accordance with instruction information from the information processing device 10.

The steering unit 70 includes a steering device 75 and a steering ECU 71. The steering device 75 includes an electric motor 75A, a conversion mechanism (not shown), and a steered shaft (not shown). The steered shaft is a steering operation shaft coupled to left and right steered wheels of the vehicle 90. The conversion mechanism converts a rotational motion of the electric motor 75A into a linear motion of the steered shaft. When the steered shaft linearly moves in response to the driving of the electric motor 75A, the steered angle of the left and right steered wheels changes. The steering ECU 71 is a control device that controls the steering device 75. The steering ECU 71 controls the electric motor 75A of the steering device 75 in accordance with instruction information from the information processing device 10. The steering device 75 adjusts the steered angle of the steered wheels under the control of the steering ECU 71.

As shown in FIG. 2, the display 30 is provided on the meter panel 96. As shown in FIG. 1, the display 30 displays information corresponding to the image data GD output by the information processing device 10. The display 30 is not limited to a display provided on the meter panel 96, and may be any display capable of displaying information to the user. For example, the display 30 may be a so-called head-up display that displays information on a windshield.

As shown in FIG. 1, the vehicle 90 includes a first switch 21 and a second switch 22 as operation switches. As shown in FIG. 2, the two operation switches are attached to the steering wheel 20 of the vehicle 90. In the example shown in FIG. 2, the two operation switches are disposed at different positions on the left and right of the steering wheel 20. The mode of the operation switch is not limited to the example shown in FIG. 2. For example, the operation switch may be a cross key type. As long as the individual functions of the two operation switches can be realized, the mode of the operation switches is not limited. As shown in FIG. 1, the first switch 21 outputs a leftward movement signal T1 as a first setting signal in response to a user's operation. That is, the leftward movement signal T1 is a signal generated based on the user's operation. The second switch 22 outputs a rightward movement signal T2 as a second setting signal in response to the user's operation. That is, the rightward movement signal T2 is a signal generated based on the user's operation. The leftward movement signal T1 and the rightward movement signal T2 are setting signals for transmitting command information regarding the setting of the target travel trajectory R of the vehicle 90. The command information carried by the leftward movement signal T1 is information indicating that the reference position RX of the target travel trajectory R is to be shifted leftward from the current time point. The reference position RX will be described later. The command information carried by the rightward movement signal T2 is information indicating that the reference position RX of the target travel trajectory R is to be shifted to the right from the current time point. In the present embodiment, a direction along a vehicle width of the vehicle 90 is treated as a lateral direction. In the present embodiment, “left” and “right” relate to the lateral direction as viewed from the driver's seat of the vehicle 90. In the present embodiment, a case in which the vehicle 90 travels on the left side of the road will be described. For example, when the vehicle 90 travels on the right side, the left and right of the following description are reversed as appropriate.

As shown in FIG. 1, the vehicle 90 includes a camera 51, a position receiver 52, and multiple traveling sensors 59. The camera 51 images the surroundings of the vehicle 90 with respect to the outside of the vehicle 90. Therefore, the camera 51 acquires the captured image C. The position receiver 52 receives its own current position coordinate Y from a global positioning satellite. The position coordinates are composed of latitude and longitude. The camera 51 and the position receiver 52 are information acquisition devices for acquiring peripheral information of the vehicle 90. Although illustration is omitted, the vehicle 90 includes an information acquisition device in addition to the camera 51 and the position receiver 52. As another example of the information acquisition device, a radar that detects an obstacle or the like present around the vehicle 90 can be exemplified. The camera 51 and the position receiver 52 repeatedly output information acquired or received by themselves to the information processing device 10.

The multiple traveling sensors 59 are sensors for detecting a traveling state of the vehicle 90. In FIG. 1, one of the multiple traveling sensors 59 is shown as a representative. Examples of the traveling sensor 59 include a sensor that detects a traveling speed of the vehicle 90, a sensor that detects an acceleration of the vehicle 90, a sensor that detects a yaw rate of the vehicle 90, and a sensor that detects a steered angle of the steered wheels. Each traveling sensor 59 repeatedly outputs information detected by the sensor itself to the information processing device 10.

In this embodiment, among the above-described components, the steering unit 70, the two operation switches, the display 30, the camera 51, the position receiver 52, the multiple traveling sensors 59, and the information processing device 10 constitute a trajectory adjustment system that adjusts the target travel trajectory R of the vehicle 90.

### Information Processing Device

As illustrated in FIG. 1, the information processing device 10 is a computer including processing circuitry. The processing circuitry includes a CPU 12 and a memory 14. The memory 14 includes three types of memories: a RAM, a ROM, and an electrically rewritable non-volatile memory. In the present embodiment, these three types are collectively referred to as a memory 14. The memory 14 stores in advance various programs describing processes to be executed by the CPU 12. The memory 14 stores in advance information necessary for the CPU 12 to execute the program.

The memory 14 stores map data M in advance. The map data M includes information of multiple nodes and multiple links. Each node represents the position coordinates of a specific point on the road. Each link is defined as a line segment connecting adjacent nodes. The link represent a road. For example, the map data M may include detailed information of the road, such as the curvature of the road, the number of travel lanes provided on the road, and the trajectories of the left and right white lines W defining the travel lanes. For example, the map data M may include information on three dimensional objects around the road, such as traffic lights and road signs.

The memory 14 stores multiple applications A in advance. The applications A are programs for controlling the motion of the vehicle 90. In FIG. 1, one of the multiple applications is shown as a representative. One of the multiple applications A is an application for realizing an autonomous driving function of causing the vehicle 90 to autonomously travel without an operation by the driver. The multiple applications A include an application for realizing a function of an advanced driver assistance system that assists an operation by a driver.

### Trajectory Generation Process

The CPU 12 has both a function of executing the above-described applications A and a function of a so-called exercise manager that supervises exercise requests from the applications A. During the execution of the application A, the CPU 12 outputs various kinds of instruction information corresponding to the exercise request from the applications A to each ECU. Hereinafter, a process of generating the instruction information of the steered angle of the steered wheel among the various kinds of instruction information will be described. This process is referred to as a trajectory generation process.

The CPU 12 repeats the trajectory generation process at a specified control cycle. The specified control cycle is, for example, a time scale of less than one second.

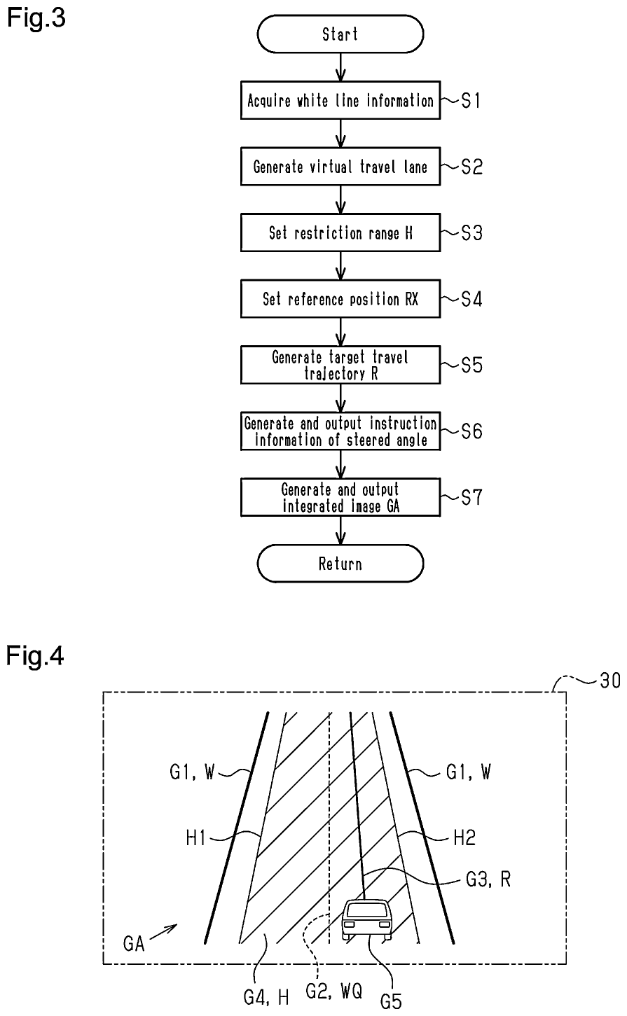

As shown in FIG. 3, when the trajectory generation process is started, the CPU 12 first performs the process of step S1. In step S1, the CPU 12 acquires the white line information of the travel lane in which the vehicle 90 is traveling. The CPU 12 acquires white line information for a predetermined range K ahead from the current position of the vehicle 90. The white line information includes the curvature of each of the left and right white lines W that define the travel lane, the distance between the left and right white lines W in the lateral direction, and the distance of each white line W from the vehicle 90 in the lateral direction. The CPU 12 acquires the white line information based on the captured image C of the camera 51. For example, the CPU 12 identifies a trajectory of the left and right white lines W, a positional relationship of the left and right white lines W, and a degree of approach of each of the left and right white lines W with respect to the center of the image in the captured image C of the camera 51. The CPU 12 grasps the white line information on the basis of the identified contents. The predetermined range K is determined in advance. The predetermined range K is, for example, slightly longer than the distance that the vehicle 90 can travel on an expressway within the control cycle of the trajectory generation process. That is, the predetermined range K has a length scale in which the curvature of each of the left and right white lines W and the distance between the left and right white lines W can be considered to be substantially constant. For example, the predetermined range K has the length scale of several tens of meters. The CPU 12 may acquire the white line information from the map data M instead of or in addition to the image C captured by the camera 51. When the map data M is used, the CPU 12 reads information about the surroundings of the vehicle 90, which is grasped from the current position coordinates Y of the vehicle 90. Upon acquiring the white line information of the travel lane, the CPU 12 advances the processing to step S2.

In step S2, the CPU 12 generates a virtual travel lane on the basis of the white line information acquired in step S1. Concretely, first, the CPU 12 identifies the shape of the center line WQ of the travel lane in the predetermined range K ahead from the current position of the vehicle 90. The center line WQ is represented as an imaginary line connecting central positions in the lateral direction of the travel lane at multiple positions distributed along the extending direction of the travel lane. In other words, the center line WQ is an imaginary line that connects the central positions distributed in the extending direction between the left and right white lines W. The CPU 12 identifies the lane width of the travel lane in accordance with the identified shape of the center line WQ. The lane width is a distance between the left and right white lines W in the lateral direction. After identifying the shape of the center line WQ and the width of the travel lane, the CPU 12 generates virtual travel lane simulating the travel lane in such a manner as to reflect these pieces of information. The CPU 12 identifying the shape of the center line WQ and the width of the travel lane corresponds to the CPU 12 acquiring these pieces of information. Instead of generating the virtual travel lane, the CPU 12 may generate a virtual road that simulates the entire road including the travel lane on which the vehicle 90 is traveling. That is, for example, when multiple travel lanes extend side by side, the virtual road may include all of the multiple travel lanes. In this way, in generating the virtual road of the entire road, the CPU 12 may comprehensively analyze various kinds of information about the road environment around the vehicle 90 by including the captured image C of the camera 51 and the map data M. Upon generating the virtual travel lane, the CPU 12 advances the processing to step S3.

In step S3, the CPU 12 sets a restriction range H for determining the target travel trajectory R of the vehicle 90. The restriction range H is a range in the lateral direction within the travel lane in which the vehicle 90 is allowed to travel. The restriction range H has a width that is symmetrical with respect to the center line WQ of the travel lane. When setting the restriction range H, the CPU 12 refers to the setting map stored in the memory 14. The setting map represents the relationship between the size of the restriction range H, the lane width, and the lane curvature. In the setting map, the restriction range H and the lane width or the lane curvature have the following relationship. If the lane curvature is the same, the restriction range His larger as the lane width is larger. If the lane width is the same, the restriction range His smaller as the lane curvature is greater, that is, as the curve is steeper. The restriction range His not limited to one that gradually changes in accordance with the lane width and/or the lane curvature as in the setting map described above, and may change in a stepwise manner with respect to the lane width and/or the lane curvature. That is, the second width value of the lane width of the travel lane is smaller than the first width value. The first width value is greater than the second width value. The restriction range H in a case in which the lane width of the travel lane is the first width value may be greater than the restriction range H in a case in which the lane width of the travel lane is the second width value. In other words, the restriction range in the case in which the lane width is the second width value is smaller than the restriction range in the case in which the lane width is the first width value. Further, the fourth curvature value of the lane curvature is greater than the third curvature value. That is, the third curvature value is less than the fourth curvature value. The restriction range H in a case in which the lane curvature is the third curvature value may be greater than the restriction range H in a case in which the lane curvature is the fourth curvature value. In other words, the restriction range in the case in which the lane curvature is the fourth curvature value is smaller than the restriction range in the case in which the lane curvature is the third curvature value.

The CPU 12 uses the setting map to determine the restriction range H of the travel lane in which the vehicle 90 is traveling. The CPU 12 applies the lane width and the lane curvature grasped from the virtual travel lane to the setting map to calculate the restriction range H corresponding to the lane width and the lane curvature. When the restriction range H is calculated, the CPU 12 determines a left boundary position H1 which is a boundary position on the left side with respect to the center line WQ and a right boundary position H2 which is a boundary position on the right side. As shown in FIG. 4, the left boundary position H1 and the right boundary position H2 are ends of the restriction range H in the lateral direction. For example, the CPU 12 defines each boundary position (H1, H2) by distances from the center line WQ. At this time, the CPU 12 assigns a positive or negative sign to each boundary position (H1, H2) for convenience, in order to distinguish between the left and right sides with respect to the center line WQ. Specifically, the CPU 12 designates the left side as negative and the right side as positive when viewed from the center line WQ, and sets each boundary position (H1, H2) to a value equal to half of the restriction range H. When the restriction range His set as described above, the CPU 12 advances the process to step S4 as shown in FIG. 3.

In step S4, the CPU 12 sets the reference position RX of the target travel trajectory R of the vehicle 90. The reference position RX is a specific position in the travel lane in the lateral direction. For example, the reference position RX is determined by the distance from the center line WQ of the travel lane, similarly to each boundary position (H1, H2) of the restriction range H. In an initial state at the start of execution of the application A, the reference position RX is set on the center line WQ. As a premise of performing the process of step S4, the CPU 12 can receive the leftward movement signal T1 from the first switch 21 and the rightward movement signal T2 from the second switch 22. The CPU 12 changes the way of setting the reference position RX depending on whether or not these setting signals are received. In a case in which the setting signal (T1, T2) has not been received until the process of the current step S4 is performed after the previous execution of step S4, the CPU 12 sets the reference position RX to be the same as that at the previous execution of step S4. On the other hand, the CPU 12 changes the reference position RX when receiving the setting signal (T1, T2) during the period from the previous execution of step S4 to the current execution of step S4. For example, when receiving the leftward movement signal T1, the CPU 12 sets a new reference position RX to a position to the left of the current reference position RX by a specified distance that has been determined in advance. At this time, if the position to the left of the current reference position RX by the specified distance is to the left of the left boundary position H1, the CPU 12 sets the new reference position RX to the left boundary position H1, instead of the position to the left of the current reference position RX by the specified distance. That is, the CPU 12 does not set the reference position RX on the left side of the left boundary position H1. When receiving the rightward movement signal T2, the CPU 12 sets a new reference position RX to a position to the right of the current reference position RX by the specified distance. At this time, if the position to the right of the current reference position RX by the specified distance is to the right of the right boundary position H2, the CPU 12 sets the new reference position RX to the right boundary position H2, instead of the position to the right of the current reference position RX by the specified distance. The value of the specified distance is set so as not to cause a sudden change in the target travel trajectory R, and further so as not to cause a sudden change in the steered angle of the vehicle 90. The specified distance may be set and changed by the user. As described above, the CPU 12 sets the reference position RX based on the setting signal (T1, T2). Further, the CPU 12 sets a reference position RX within a restriction range H in the lateral direction within the travel lane. Regarding the process of step S4, even in a case in which the CPU 12 has not received the setting signals (T1, T2) during a period from the previous execution of step S4 to the current execution of the process of step S4, the CPU 12 sets the reference position RX again if the previously set reference position RX is out of the restriction range H set in step S3. That is, if the previous reference position RX is to the left of the left boundary position H1, the CPU 12 sets the new reference position RX to the left boundary position H1, which is the left limit position. Similarly, if the previous reference position RX is to the right of the right boundary position H2, the CPU 12 sets the new reference position RX to the right boundary position H2, which is the right limit position. After setting the reference position RX, the CPU 12 advances the process to step S5.

In step S5, the CPU 12 generates the target travel trajectory R of the vehicle 90 on the virtual travel lane. Specifically, first, the CPU 12 identifies the reference position RX with reference to, for example, the center line WQ at each position in the extending direction of the travel lane for the predetermined range K ahead from the current position of the vehicle 90. That is, the CPU 12 sets multiple reference positions RX of the target travel trajectory R in the extending direction of the travel lane based on the setting signal. Each of the reference positions RX is a specific position in a lateral direction within the travel lane at a corresponding position in the extending direction of the travel lane. The CPU 12 generates, as the target travel trajectory R, an imaginary line connecting the reference positions RX in the extending direction of the travel lane with respect to the predetermined range K. After generating the target travel trajectory R of the vehicle 90, the CPU 12 advances the process to step S6.

In step S6, the CPU 12 generates instruction information of a steered angle for the steering device 75. First, the CPU 12 identifies the position of the vehicle 90 in the lateral direction in the travel lane based on the white line information acquired in step S1. The CPU 12 generates instruction information of a steered angle necessary to cause the vehicle 90 to travel along the target travel trajectory R based on the information of the position of the vehicle 90 and the information of the traveling state of the vehicle 90 at the present time. For example, when the reference position RX is shifted leftward in the step S4, the CPU 12 generates the instruction information of the steered angle so that the vehicle 90 heads leftward. The traveling state of the vehicle 90 includes the magnitude of variables related to the traveling trajectory of the vehicle 90, such as the steered angle of the steered wheels, the yaw rate of the vehicle 90, the traveling speed of the vehicle 90, and the acceleration of the vehicle 90. When generating the instruction information of the steered angle, the CPU 12 outputs the instruction information to the steering device 75. The CPU 12 substantially outputs the instruction information to the steering ECU 71. Thereafter, the CPU 12 advances the processing to step S7.

In step S7, CPU 12 generates an integrated image GA. As shown in FIG. 4, the integrated image GA includes the following five images. The first image G1 includes lines representing the trajectories of the left and right white lines W defining the travel lane. The second image G2 is a line representing the trajectory of the center line WQ of the travel lane. In FIG. 4, the second image G2 is represented by a dotted line. The third image G3 is a line representing the target travel trajectory R. The fourth image G4 is a belt-shaped line in which the restriction range His continuous in the extending direction of the travel lane. That is, the fourth image G4 represents the restriction range H. In FIG. 4, the region of the belt-shaped line is shown by hatching. The fifth image G5 is an icon representing the current position of the vehicle 90. The integrated image GA covers the predetermined range K from the current position of the vehicle 90.

When generating the integrated image GA, the CPU 12 first generates a first image G1 serving as a base of the integrated image GA. That is, the CPU 12 generates the first image G1 so as to reflect the trajectories of the left and right white lines W and the distance between the left and right white lines W identified in step S1 and step S2. The CPU 12 superimposes the second image G2, the third image G3, the fourth image G4, and the fifth image G5 on the first image G1. At this time, the CPU 12 sets the center line WQ such that the center line WQ is located at the center between the left and right white lines W at each position in the extending direction of the travel lane. In addition, the CPU 12 maintains the positional relationship of the target travel trajectory R with the left and right white lines W and the center line WQ at each position in the extending direction of the travel lane. Further, the CPU 12 maintains the positional relationship between the left and right white lines W and the center line WQ, and the left boundary position H1 and the right boundary position H2 of the restriction range H at each position in the extending direction of the travel lane. Further, the CPU 12 superimposes the fifth image G5 on each of the images so as to reflect the current position of the vehicle 90 identified in step S6 with respect to the left and right white lines W. When the integrated image GA is generated as described above, the CPU 12 generates the image data GD for displaying the integrated image GA. The image data GD includes, in addition to the integrated image GA itself, various kinds of information such as a scale for displaying the integrated image GA and an instruction to display the integrated image GA. After generating the image date GD, the CPU 12 outputs the image date GD to the display 30. In response to the output of the image data GD by the CPU 12, the display 30 displays the integrated image GA. Thereafter, the CPU 12 temporarily ends the series of processes of the trajectory generation process. The CPU 12 returns to the process of step S1.

### Operation of Embodiment

It is assumed that the CPU 12 is in charge of the steering control of the vehicle 90. In such a situation, it is assumed that the user operates the first switch 21. Then, the first switch 21 outputs the leftward movement signal T1. When receiving the leftward movement signal T1, the CPU 12 generates the target travel trajectory R by setting the new reference position RX to a position to the left of the current reference position RX by the specified distance. The CPU 12 controls the steered angle of the steered wheel in accordance with the target travel trajectory R. Thereafter, it is assumed that the user operates the second switch 22. Then, the second switch 22 outputs the rightward movement signal T2. When receiving the rightward movement signal T2, the CPU 12 generates the target travel trajectory R by setting the new reference position RX to a position to the right of the current reference position RX by the specified distance. The CPU 12 controls the steered angle of the steered wheel in accordance with the target travel trajectory R.

### Advantages of Embodiment

(1) The setting signal for the CPU 12 to set the reference position RX is generated based on the user's operation. That is, the user can customize the position of the target travel trajectory R in the lateral direction. Since such customization is enabled, the CPU 12 can generate the target travel trajectory R according to the intention of the user.

(2) The CPU 12 changes the reference position RX to the left or right in response to receiving the leftward movement signal T1 or the rightward movement signal T2. With such a configuration, the user can freely change the target travel trajectory R to the left or right in accordance with the user's travel feeling. That is, the configuration of the present embodiment is suitable for the user to customize the target travel trajectory R to the left and right.

(3) The CPU 12 variably sets the restriction range H for restricting the reference position RX in accordance with the lane width and the lane curvature of the travel lane. Accordingly, for example, in a road environment in which the safety in traveling of the vehicle 90 is considered to be high, such as a wide lane width or a straight travel lane, the restriction range H is set to be wide. Therefore, in such a road environment, the degree of freedom of customization by the user is increased. On the other hand, the restriction range H is set to be narrow in a road environment in which the safety in traveling of the vehicle 90 tends to be low, for example, when the lane width is narrow or the curve of the travel lane is sharp, that is, the lane curvature is large. Therefore, in such a road environment, a request for changing the reference position RX by the user is regulated to some extent. In general, in the configuration of the present embodiment, it is possible to customize the target travel trajectory R in accordance with the road environment.

(4) Regarding the positional relationship between both ends and the center position of the travel lane and the target travel trajectory R, the positional relationship sensuously perceived by the user does not necessarily match the actual positional relationship. For example, the actual position of the vehicle 90 may be closer to the left or the right than the position perceived by the user. In this regard, the CPU 12 displays the integrated image GA in which the trajectories of the left and right white lines W, the trajectory of the center line WQ, and the target travel trajectory R are integrated. Thus, the user can accurately grasp the actual positional relationship between these trajectories. The user can adjust the target travel trajectory R while grasping these actual positional relationships. Therefore, for example, the target travel trajectory R can be prevented from being set to a position different from that intended by the user. Further, the CPU 12 includes the restriction range H in the integrated image GA. As a result, the user can adjust the target travel trajectory R after understanding how much the target travel trajectory R can be further changed. As a result, there is no concern that the user might unnecessarily operate the operation switch, for example, even when the reference position RX can no longer be changed. In general, the configuration of the present embodiment is highly convenient when the user adjusts the target travel trajectory R using the operation switch.

### Modifications

The above-described embodiment may be modified as follows. The above-described embodiments and the following modifications can be combined as long as the combined modifications remain technically consistent with each other.

The method of setting the restriction range His not limited to the example of the above embodiment. The restriction range H is not limited to the lane width and the lane curvature, and may reflect other characteristics of the road on which the vehicle 90 is traveling. In this case, the restriction range H may be set asymmetrically with respect to the center line WQ of the travel lane. For example, in a case in which multiple travel lanes in which the traveling direction of the vehicle 90 is the same extend side by side, such as two lanes on one side or three lanes on one side, the restriction range H may be set as follows. That is, in a case in which the vehicle 90 is traveling in the rightmost travel lane among the multiple travel lanes, the restriction range His set such that the width on the right side with respect to the center line WQ of the travel lane is larger than the width on the left side. Further, when the vehicle 90 is traveling in the leftmost travel lane of the multiple travel lanes, the restriction range H is set such that the width on the left side with respect to the center line WQ of the travel lane is larger than the width on the right side. Depending on the travel feeling of the user, the user may want to set the target travel trajectory R at a position away from the adjacent travel lane. As in the configuration of the present modification, if the restriction range H is set so as to expand in a direction away from the adjacent travel lane, it is easy to satisfy a user's request in a case in which the user wishes to set the target travel trajectory R so as to secure the distance from the adjacent travel lane.

In addition to the above example, various settings of the restriction range H can be considered. For example, the restriction range H may be set in consideration of a decrease in road shoulder due to construction or the like. Specifically, for example, in a case in which the road shoulder on the right side has decreased, the restriction range His set such that the width on the left side with respect to the center line WQ of the travel lane is larger than the width on the right side. Additionally, when the vehicle is traveling in the left lane on a two-way road, the restriction range H may be set such that the width on the left side of the lane center line WQ is larger than the width on the right side. In this case, the restriction range H is set so as to easily secure a space from the lane in the opposite direction. For example, in a case in which the bicycle traveling zone extends on the left side of the travel lane and the vehicle travels on the left lane, the restriction range H may be set such that the width on the left side with respect to the center line WQ of the travel lane is larger than the width on the right side. In this case, the restriction range His set so as to easily secure a space from the bicycle traveling zone. As described above, the restriction range H may be set in consideration of various situations to be considered in traveling of the vehicle 90. When the road environment in which the vehicle 90 is placed is grasped, various kinds of information such as the map data M and road signs included in the captured image C of the camera 51 may be used.

It is not essential to set the restriction range H. Since the user sets the reference position RX in consideration of the road environment, the target travel trajectory R suitable for various road environments can be set.

The setting signal is not limited to changing the reference position RX to the left or right. For example, the following configuration may be adopted as the setting signal and the configuration related thereto. In addition to the first switch 21 and the second switch 22, an inward curve switch and an outward curve switch are attached to the steering wheel 20 as operation switches. The inward curve switch as a third switch outputs a radially inward setting signal T3 as a third setting signal in response to a user's operation. The outward curve switch as the fourth switch outputs a radially outward setting signal T4 as a fourth setting signal in response to the user's operation. The CPU 12 is configured to receive the radially inward setting signal T3 and the radially outward setting signal T4. When the CPU 12 once receives the radially inward setting signal T3 during the execution of the application A, the CPU 12 always treats the command information carried by the radially inward setting signal T3 as valid information until the CPU 12 receives a cancel signal in response to the operation of a separately prepared cancel switch. Similarly, when the CPU 12 once receives the radially outward setting signal T4, the CPU 12 always treats the command information carried by the radially outward setting signal T4 as valid until the CPU 12 receives the cancel signal. The requirement that the curvature of the lane in which the vehicle 90 is traveling is greater than the specified value is referred to as a setting requirement. The command information carried by the radially inward setting signal T3 sets the reference position RX to a first specified position radially inward of the center line WQ of the travel lane, on condition that the setting requirement is satisfied. The command information carried by the radially outward setting signal T4 is to set the reference position RX to a second specified position radially outward of the center line WQ of the travel lane, on condition that the setting requirement is satisfied. The specified value is determined in advance as a value at which the travel lane can be regarded as a substantially straight line. The first specified position and the second specified position are determined in advance in consideration of traveling stability of the vehicle 90 and the like.

When the radially inward setting signal T3 and the radially outward setting signal T4 are employed, the trajectory generation process may be configured as follows. That is, in step S2, the CPU 12 determines whether or not the lane curvature is greater than a specified value in accordance with the generation of the virtual travel lane. When the lane curvature is equal to or less than a specified value, that is, when the travel lane can be regarded as a substantially straight line, the CPU 12 performs the processing after step S3 with the same processing contents as in the above-described embodiment. On the other hand, when the lane curvature is greater than the specified value, that is, when the travel lane can be regarded as a curve, the CPU 12 cancels the processing of step S3. In this case, the CPU 12 performs the following processing in step S4. In step S4, when the command information of the radially inward setting signal T3 is valid, the CPU 12 sets the reference position RX to a first specified position radially inward of the center line WQ of the travel lane. That is, when receiving the radially inward setting signal T3, the CPU 12 sets the reference position RX to a radially inward position with respect to the center of the travel lane in the lateral direction on condition that the lane curvature of the travel lane is greater than the specified value, which is determined in advance. On the other hand, when the command information of the radially outward setting signal T4 is valid, the CPU 12 sets the reference position RX to a second specified position radially outward of the center line WQ of the travel lane. That is, when receiving the radially outward setting signal T4, the CPU 12 sets the reference position RX to a radially outward position with respect to the center of the travel lane in the lateral direction on condition that the lane curvature of the travel lane is greater than the specified value. The CPU 12 sets the reference position RX to the center line WQ of the travel lane when both the command information of the radially inward setting signal T3 and the command information of the radially outward setting signal T4 are not valid. After setting the reference position RX in this way, the CPU 12 advances the process to step S5 and subsequent steps. The CPU 12, in this manner, repeatedly performs the trajectory generation process. When the lane curvature returns to a value less than or equal to the specified value after having been greater than the specified value, the CPU 12 resets the reference position RX to the position it was at before the lane curvature exceeded the specified value. When this modification is adopted, the following advantages are obtained. Depending on the user's driving feel, there may be situations where, for instance, the user wishes to maintain the target travel trajectory R consistently closer to the inside of curves or consistently closer to the outside of curves when curves are continuous. When the radially inward setting signal T3 and the radially outward setting signal T4 are employed, such customization with respect to the inner side or the outer side of the curve is enabled.

In the case in which the radially inward setting signal T3 and the radially outward setting signal T4 are employed as in the above modification, the first specified position may be freely changed in accordance with the operation of the inward curve switch by the user. Similarly, the second specified position may be freely changed according to the operation of the outward curve switch by the user. When a configuration in which the user can adjust the first specified position and the second specified position is adopted, the restriction range may be determined in consideration of a road environment or the like.

It is not essential to use the leftward movement signal T1 and the rightward movement signal T2 as the setting signals. For example, in the case in which the radially inward setting signal T3 and the radially outward setting signal T4 of the above-described modification are employed, the leftward movement signal T1 and the rightward movement signal T2 may be omitted. In this case, the reference position RX when the lane curvature is equal to or less than a specified value may be set as the center line WQ of the travel lane.

The setting signal is not limited to the above example, and may be any signal as long as it transmits command information regarding the target travel trajectory R of the vehicle 90 to the information processing device 10. For example, the setting signal may set the target travel trajectory R at an intersection. In this case, the setting signal may instruct the information processing device 10 to take the target travel trajectory R close to the left white line when the vehicle turns left at the intersection and close to the right white line when the vehicle turns right at the intersection.

The integrated image GA is not limited to the example of the above embodiment. The integrated image GA only needs to show the center line WQ, the target travel trajectory R, and the restriction range H together with the left and right white lines W, and the way of displaying these pieces of information may be changed as appropriate. For example, the target travel trajectory R may be a belt-shaped line. The fifth image G5 is not essential. The integrated image GA may include images other than the images superimposed in the above-described embodiment, such as multiple travel lanes extending side by side.

It is not essential to display the integrated image GA. Even without the integrated image GA, the user can set the optimum target travel trajectory R by appropriately changing the reference positions RX.

The output source that outputs the setting signal to the information processing device 10 is not limited to the switch. The output source may be any source capable of outputting a setting signal regarding the target travel trajectory R of the vehicle 90 to the information processing device 10.

The information processing device 10 may be modified if it includes a CPU and a ROM and executes software processing. The information processing device 10 is not limited to this configuration. That is, the information processing device 10 may have any one of the following configurations (a), (b), and (c).

(a) The information processing device 10 includes one or more processors that execute various processes according to computer programs. Each processor includes a CPU and a memory, such as a RAM and a ROM. The memory stores program code or instructions configured to cause the CPU to execute processes, for example, an information providing process. A memory, which is a non-transitory computer readable medium, includes any medium that is accessible by a versatile or dedicated computer.

(b) The information processing device 10 includes one or more dedicated hardware circuits that execute various processes. Examples of the dedicated hardware circuits include an application specific integrated circuit (ASIC) and a field programmable gate array (FPGA).

(c) The information processing device 10 includes a processor that executes part of various processes according to programs and a dedicated hardware circuit that executes the remaining processes.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle information processing device, comprising processing circuitry, wherein the processing circuitry is configured to:
receive a setting signal related to a target travel trajectory of a vehicle, the setting signal being generated based on an operation by a user;
acquire white line information of a travel lane on which the vehicle is traveling;
acquire information on a shape of a center line of the travel lane and a width of the travel lane for a predetermined range ahead from a current position of the vehicle based on the white line information;
based on the setting signal, set multiple reference positions of the target travel trajectory in an extending direction of the travel lane, each of the reference positions being a specific position in a lateral direction in the travel lane at a position in the extending direction of the travel lane, the lateral direction being a direction along a width of the vehicle;
generate the target travel trajectory based on the reference positions, the target travel trajectory being an imaginary line obtained by connecting the reference positions to each other in the extending direction of the travel lane;
generate instruction information of a steered angle of a steered wheel of the vehicle so as to cause the vehicle to travel along the target travel trajectory; and
output the instruction information to a steering device of the vehicle so as to adjust the steered angle.

2. The vehicle information processing device according to claim 1, wherein
the setting signal includes a leftward movement signal or a rightward movement signal, and
the processing circuitry is configured to, when setting the reference positions:
upon receiving the leftward movement signal, set a new one of the reference positions to a position to the left of the current reference position by a specified distance that is determined in advance; and
upon receiving the rightward movement signal, set a new one of the reference positions to a position to the right of the current reference position by the specified distance.

3. The vehicle information processing device according to claim 2, wherein
the processing circuitry sets the reference positions within a restriction range in the lateral direction in the travel lane,
a second width value of a lane width of the travel lane is less than a first width value, and the restriction range in a case in which the lane width is the second width value is smaller than the restriction range in a case in which the lane width is the first width value, and
a fourth curvature value of a lane curvature of the travel lane is greater than a third curvature value, and the restriction range in a case in which the lane curvature is the fourth curvature value is smaller than the restriction range in a case in which the lane curvature is the third curvature value.

4. The vehicle information processing device according to claim 3, wherein the processing circuitry is further configured to:
generate an integrated image by superimposing, on a first image representing trajectories of left and right white lines defining the travel lane, a second image representing a center position of the travel lane, a third image representing the target travel trajectory, and a fourth image representing the restriction range; and
output image data for displaying the integrated image to an outside.

5. The vehicle information processing device according to claim 1, wherein
the travel lane includes a curve,
the setting signal includes a radially inward setting signal or a radially outward setting signal, and
the processing circuitry is configured to, when setting the reference positions:
upon receiving the radially inward setting signal, set each of the reference positions to a radially inward position with respect to a center of the travel lane in the lateral direction on condition that a lane curvature of the travel lane is greater than a specified value that is determined in advance; and
upon receiving the radially outward setting signal, set each of the reference positions to a radially outward position with respect to the center of the travel lane in the lateral direction on condition that the lane curvature is greater than the specified value.
